(19) United States
(12) Patent Application Publication
(10) Pub. No.: US 2011/0248614 A1
(43) Pub. Date: Oct. 13, 2011

(54) Safety LED Bulb with Inside Heat Sink

(76) Inventor: Xiao Ping WANG, Pudong (CN)

(21) Appl. No.: 12/755,683

(22) Filed: Apr. 7, 2010

(51) Int. Cl. H01J 61/52

(52) U.S. Cl. 313/46

(57) ABSTRACT

An LED bulb has an external power supply connector, a bulb cup mounted to the external power supply connector, a fan; an internal power supply receiving power from the external power supply connector, and providing an output power. The bulb also includes a heatsink, an LED light source mounted to the heatsink and receiving power from the internal power supply, and a bulb cover covering the LED light source. The heat sink is mounted at a connection part of the bulb cup and bulb cover and the bulb cup is separated from the LED light source in the bulb cover. The bulb cup has a plurality of air vents formed as apertures in the surface of the bulb cup which can comprise a pair of rows of air vents such as a lower row and an upper row.

### BACKGROUND OF THE INVENTION

1. Field of the invention

The present invention relates to a light emitting diode (LED) bulb, and more particularly to a safety LED bulb with inside heat sink.

2. Description of Related Art

Light emitting diode (LED) technology has achieved great improvements in recent years. The performance of LED bulbs in general lighting applications has also improved as well. Thanks to advantages like long life operation, short start time, energy savings, no UV and no environment pollution, and safe operation among other things, LED bulbs have become a main stream lighting technology.

Currently however, the LED bulb is an optoelectronic product, which normally only provides 15% to 25% efficiency, such that a smaller fraction of electric energy is actually transformed into light, with the rest being transferred to thermal energy. The low thermodynamic efficiency, even if increased in the future would still steadily increase the temperature of LED bulbs. Due to this phenomenon, improper design of a heat sink will cause degradation, which is a low efficiency of the bulb, or in extreme circumstances may burn out the entire element. Therefore, designing LED bulb that is both safe and good has already been put on the engineering design agenda of product designers.

### SUMMARY OF THE INVENTION

An LED bulb has an external power supply connector, a bulb cup mounted to the external power supply connector, a fan; an internal power supply receiving power from the external power supply connector, and providing an output power. The bulb also includes a heatsink, an LED light source mounted to the heatsink and receiving power from the internal power supply, and a bulb cover covering the LED light source. The heat sink is mounted at a connection part of the bulb cup and bulb cover and the bulb cup is separated from the LED light source in the bulb cover. The bulb cup has a plurality of air vents formed as apertures in the surface of the bulb cup which can comprise a pair of rows of air vents such as a lower row and an upper row. The air vents are preferably configured to provide natural convection vortex flow. The heatsink is mounted so that there is a gap between the heatsink and the fan. The bulb cup has a plurality of air vents formed as apertures in the surface of the bulb cup. The air vents are configured to provide natural convection vortex flow.

### BRIEF DESCRIPTION OF THE DRAWINGS

FIG. 1 is an external side view of the present invention.

FIG. 2 is a cross section side view of the present invention.

FIG. 3 is an exploded assembly view of the present invention.

FIG. 4 is a side view of the of the bulb cup of present invention.

FIG. 5 is a vertical view of FIG. 4.

FIG. 6 is a side view of the heat sink of the present invention.

FIG. 7 is a top view of the heat sink.

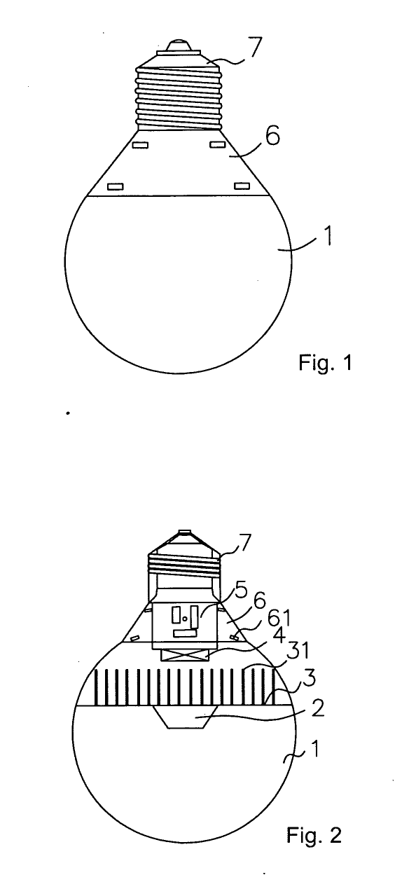

The callout list of elements is useful in referencing the element numbers of the drawings:
1 Bulb cover
2 LED light source
3 Heat sink
31 Fin
4 Fan
5 Internal power supply
6 Bulb cap
61 Bulb cup vents
7 Bulb cup for connection to external electrical power

### DETAILED DESCRIPTION OF THE PREFERRED EMBODIMENT

The present invention LED bulb is shown in the figures. The bulb has a heat sink that includes a bulb cup for connection to external electrical power 7, bulb cup 6, internal power supply 5, and heat sink 3. The LED light source 2, and bulb cover 1 are connected to a variety of internal components that are mounted inside the bulb cup 6 which operates as a housing for internal components. The internal components include an internal power supply 5, a heat sink 3 and plurality of fins 31 which are mounted inside the bulb cup 6, on the upper part of the bulb cover, or the connection part of the bulb cup 6 and bulb cover 1. The LED light source 2 is mounted on the bottom of the heat sink 3 which is the side near the bulb cover. The heat sink 3 is put inside the bulb cover 1, and also divides the bulb cover into two separated spaces.

The heat dissipation strategy is to form the row of vents 61 on the bulb cup 6. The vents 61 on the bulb cup can be one row or preferably two rows. In actual use, for lower power LED lights, the heat sink 3 can possibly be without fins 31, such as if the heat sink were just a flat piece of metal. The vents 61 on the bulb cup are shaped and preferably arranged so that vortex airflow provides heat dissipation with the revolving door effect of natural convection. Thus, the double row configuration is preferably configured in a vortex airflow configuration.

The LED light source 2 is connected directly to solid metal center of heat sink 3. The heat can be transferred to heat sink 3 and fins 31, although heat sink 3 is isolated by non-insulated light cup 6, the air outside can pass through vents 61 extract heat via heat sink 3 and fins 31. The configuration of two rows of vents preferably makes the air flow exchange that of a double row vortex airflow configuration like a revolving door, which help dissipate heat on heat sink 3. This more cost-effective and basic version would mainly apply to lower power LED lighting where natural convection alone is sufficient for thermal dissipation needs.

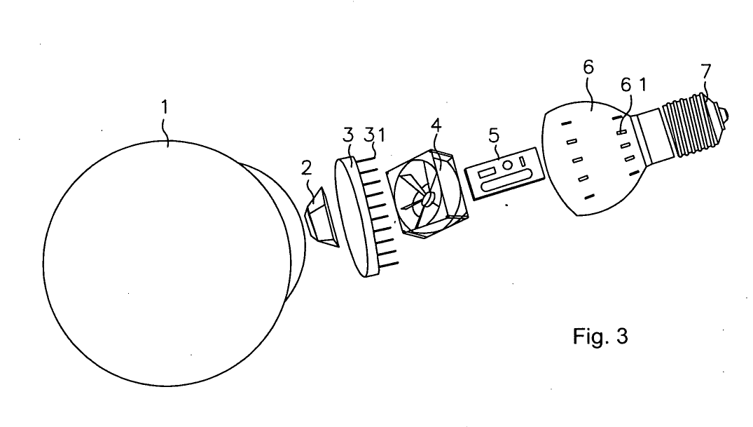

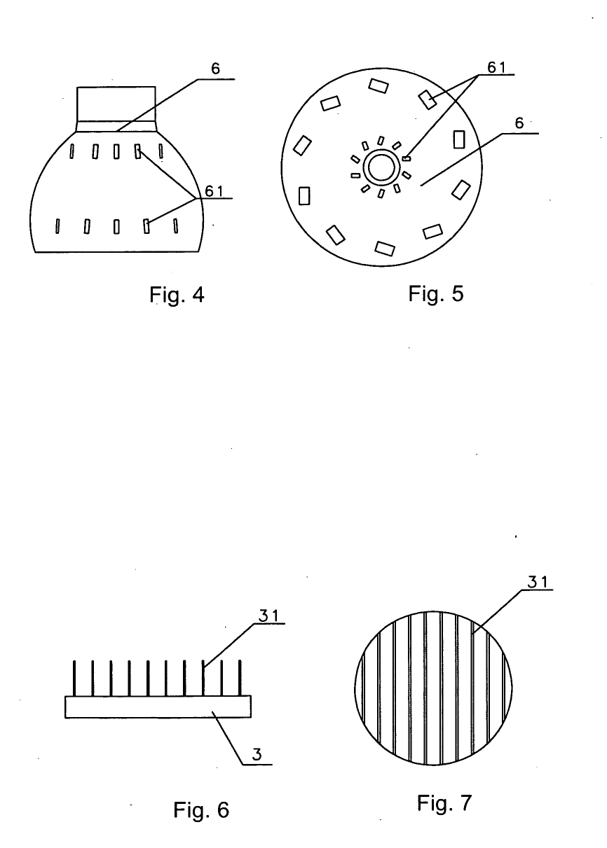

For higher power LED lighting products, besides the basic design as described above, the LED bulb has a heat sink should further include a fan 4 along with the other above-mentioned elements such as the connection to external electrical power 7, bulb cup 6, internal power supply 5, heatsink 3, LED light source 2, and bulb cover 1, FIG. 3. An internal power supply 5, heat sink 3 with fins 31 are mounted inside the bulb cup 6 or on the upper part of the bulb cover, or the connection part of the bulb cup 6 and bulb cover 1. The LED light source 2 is mounted on the bottom of the heat sink 3, the side near bulb cover 1. The fan is preferably mounted by the heatsink 3 though it could be mounted to the bulb cup 6 also. The fan can be powered by the internal power supply such as a compact electronic ballast, or by a thermoelectric element incorporated as a part of the heatsink element mounted on the LED facing surface of the heatsink between the LED light source and the heatsink. Preferably, there is a gap between the fan and the heatsink. The inclusion of the fan for providing forced convection in addition to natural connection is preferred high power LED lighting products.

The foregoing describes the preferred embodiments of the invention. Modifications may be made without departing from the spirit and scope of the invention as set forth in the following claims. The present invention is not limited to the embodiments described above, but encompasses any and all embodiments within the scope of the following claims. Therefore, while the presently preferred form of the massaging chair has been shown and described, and several modifications thereof discussed, persons skilled in this art will readily appreciate that various additional changes and modifications may be made without departing from the spirit of the invention, as defined and differentiated by the following claims.

1. An LED bulb comprising:
a. an external power supply connector;
b. a bulb cup mounted to the external power supply connector;
c. a fan;
d. an internal power supply receiving power from the external power supply connector, and providing an output power;
e. a heatsink;
f. an LED light source mounted to the heatsink and receiving power from the internal power supply,
g. a bulb cover covering the LED light source, wherein the heat sink is mounted at a connection part of the bulb cup and bulb cover and wherein the bulb cup is separated from the LED light source in the bulb cover.

2. The LED bulb with heat sink of claim 1, wherein the bulb cup has a plurality of air vents formed as apertures in the surface of the bulb cup.

3. The LED bulb with heat sink of claim 1, wherein the bulb cup has a plurality of air vents formed as apertures in the surface of the bulb cup, wherein the plurality of air vents comprises a pair of rows of air vents, namely a lower row and an upper row, wherein the air vents are configured to provide natural convection vortex flow.

4. The LED bulb with heat sink of claim 1, wherein the heatsink is mounted so that there is a gap between the heatsink and the fan.

5. The LED bulb with heat sink of claim 4, wherein the bulb cup has a plurality of air vents formed as apertures in the surface of the bulb cup.

6. The LED bulb with heat sink of claim 4, wherein the bulb cup has a plurality of air vents formed as apertures in the surface of the bulb cup, wherein the plurality of air vents comprises a pair of rows of air vents, namely a lower row and an upper row, wherein the air vents are configured to provide natural convection vortex flow.

7. The LED bulb with heat sink of claim 1, wherein the heatsink is mounted to the bulb cover so that there is a gap between the heatsink and the fan.

8. The LED bulb with heat sink of claim 7, wherein the bulb cup has a plurality of air vents formed as apertures in the surface of the bulb cup.

9. The LED bulb with heat sink of claim 7, wherein the bulb cup has a plurality of air vents formed as apertures in the surface of the bulb cup, wherein the plurality of air vents comprises a pair of rows of air vents, namely a lower row and an upper row, wherein the air vents are configured to provide natural convection vortex flow.
